(19) United States
(12) Patent Application Publication
(10) Pub. No.: US 2015/0177704 A1
(43) Pub. Date: Jun. 25, 2015

(54) Alarm Clock Projector

(71) Applicant: Liz Howell, Howell, NJ (US)

(72) Inventor: Liz Howell, Howell, NJ (US)

(21) Appl. No.: 14/580,196

(22) Filed: Dec. 22, 2014

Related U.S. Application Data
(60) Provisional application No. 61/919,311, filed on Dec. 20, 2013.

(51) Int. Cl. G04G 13/02; G04G 11/00; G04G 99/00; G04G 21/08

(52) U.S. Cl. CPC G04G 13/02; G04G 21/08; G04G 11/00; G04G 99/00

(57) ABSTRACT

An alarm clock is disclosed herein. In one embodiment, the alarm clock is Bluetooth and/or Wifi enabled and includes tablet having a touch screen thereon. The touch screen that can be used to input information or control a user interface thereof. The tablet further includes speakers and a projector, wherein the projector is adapted to project various images therefrom. The display screen, the speakers, and the projector are connected to an input/output circuitry, which is electrically connected to a CPU. The CPU is further connected to clock, a connectivity module, and at least one memory that stores software applications therein. The user can selectively display icons for the software applications on the user interface or access the software applications therefrom via the touch screen. Additionally, the user can set the alarm clock and select an image to be projected when the alarm clock goes off at a preset time.

### CROSS REFERENCE TO RELATED APPLICATION

This application claims the benefit of U.S. Provisional Application Ser. No. 61/919,311 filed on Dec. 20, 2013. The above identified patent application is herein incorporated by reference in its entirety to provide continuity of disclosure.

### FIELD OF THE INVENTION

The present invention relates to an alarm clock. More specifically, the present invention pertains to an improved alarm clock that is adapted to project a two-dimensional and/or three-dimensional image therefrom. In one embodiment, the alarm clock of the present invention is further adapted for use with various software applications.

### BACKGROUND OF THE INVENTION

### Description of the Prior Art

Devices have been disclosed in the prior art that claim wireless devices that have alarm clocks and various software applications. These include devices that have been patented and published in patent application publications. The foregoing is a list of devices deemed most relevant to the present disclosure, which are herein described for the purposes of highlighting and differentiating the unique aspects of the present invention, and further highlighting the drawbacks existing in the prior art.

Some of these devices disclose devices that can project light or images. Specifically, U.S. Patent Application Publication Number 2011/0058456 discloses an alarm clock can project light towards the user so as to encourage the user to wake up. U.S. Pat. No. 6,798,720 disclose alarm clocks that comprises an optical unit and an optoelectrical unit for producing the images of the data to be projected. The images may comprise the time, alarm time, the date, the temperature, and weather forecast, and the like.

Other devices disclose alarm clocks that can display personalized information. U.S. Pat. No. 8,195,203, U.S. Pat. No. 7,506,035, and U.S. Pat. No. 6,967,900 disclose alarm clocks that can connect to a network that is connected to a data source. The alarm clocks generally include a memory for storing information from the data source, and a processor for selectively displaying the information on the display screen. Accordingly, the alarm clocks further include means to select the information that the user desires to view.

The devices disclosed in the prior art have several known drawbacks. These devices do not disclose alarm clocks that can wirelessly download various software applications to customize the user interface on the display screen. Thus, the prior art devices are limited in that the alarm clocks can only be used with preexisting software applications. Additionally, the prior art devices are not adapted to project alerts, messages, or images when the alarm clock goes off. The present invention overcomes these limitations by disclosing a wireless alarm clock having a built-in projector that can project two-dimensional and/or three-dimensional images. The alarm clock can also download software applications and updates, wherein the applications provide weather forecasts, news, alerts, stock, traffic updates, music and the like.

It is therefore submitted that the present invention is substantially divergent in design elements from the prior art, and consequently it is clear that there is a need in the art for an improvement to alarm clocks. In this regard, the instant invention substantially fulfills these needs.

### SUMMARY OF THE INVENTION

In view of the foregoing disadvantages inherent in the known types of alarm clocks now present in the prior art, the present invention provides a new and improved alarm clock projector wherein the same can be utilized for waking up a user and displaying customized contents.

In one embodiment, the present invention provides an alarm clock having a touch screen for inputting information, speakers for playing sound, and a projector for displaying images on a medium. The touch screen, the speakers, and the projector are connected to an input/output circuitry. The input/output circuitry is connected to the CPU, which is in electrical communication with a clock, a connectivity module, and at least one memory, which may comprise RAM, ROM, and/or flash memory for storing software applications. The connectivity module comprises a Bluetooth module or a Wifi module so that the alarm clock can be wirelessly connected to the Internet to download the software applications and updates relating thereto.

The touch screen includes a user interface thereon. The user interface comprises settings used to set the alarm clock, to select a sound for the speakers, and to select an image, a message, or an alert to be projected from the projector when the alarm clock goes off at a preset time. Additionally, the user interface can be customized to selectively display certain software applications. As will be described in further detail herein, there are many additional features of the instant invention.

It is therefore an object of the invention to provide a new and improved alarm clock projector that has all of the advantages of the prior art and none of the disadvantages.

Another object of the present invention is to provide a new and improved alarm clock projector that can display customized two-dimensional images.

Yet another object of the present invention is to provide a new and improved alarm clock projector that can wirelessly connect to the Internet to download software applications and updates.

Still yet another object of the present invention is to provide a new and improved alarm clock projector that can display a customized content on a user interface.

Still yet another object of the present invention is to provide a new and improved alarm clock projector that can produce audible and visual alarm.

Still yet another object of the present invention is to provide a new and improved alarm clock projector that comprises a fragrance emitter.

Still yet another object of the present invention is to provide a new and improved alarm clock projector wherein the device may be readily fabricated from materials that permit relative economy and are commensurate with durability.

Other objects, features, and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein the numeral annotations are provided throughout.

FIG. 1 shows a perspective view of the present invention.

FIG. 2 shows a view of the present invention projecting an image.

FIG. 3 shows a schematic diagram of the present invention.

FIG. 4 shows a diagram of the connectivity system of the present invention.

### DETAILED DESCRIPTION OF THE INVENTION

References are made herein to the attached drawings. Like reference numerals are used throughout the drawings to depict like or similar elements of the alarm clock projector. For the purposes of presenting a brief and clear description of the present invention, the preferred embodiment will be discussed as used for waking up a user and displaying customized contents. The figures are intended for representative purposes only and should not be considered to be limiting in any respect.

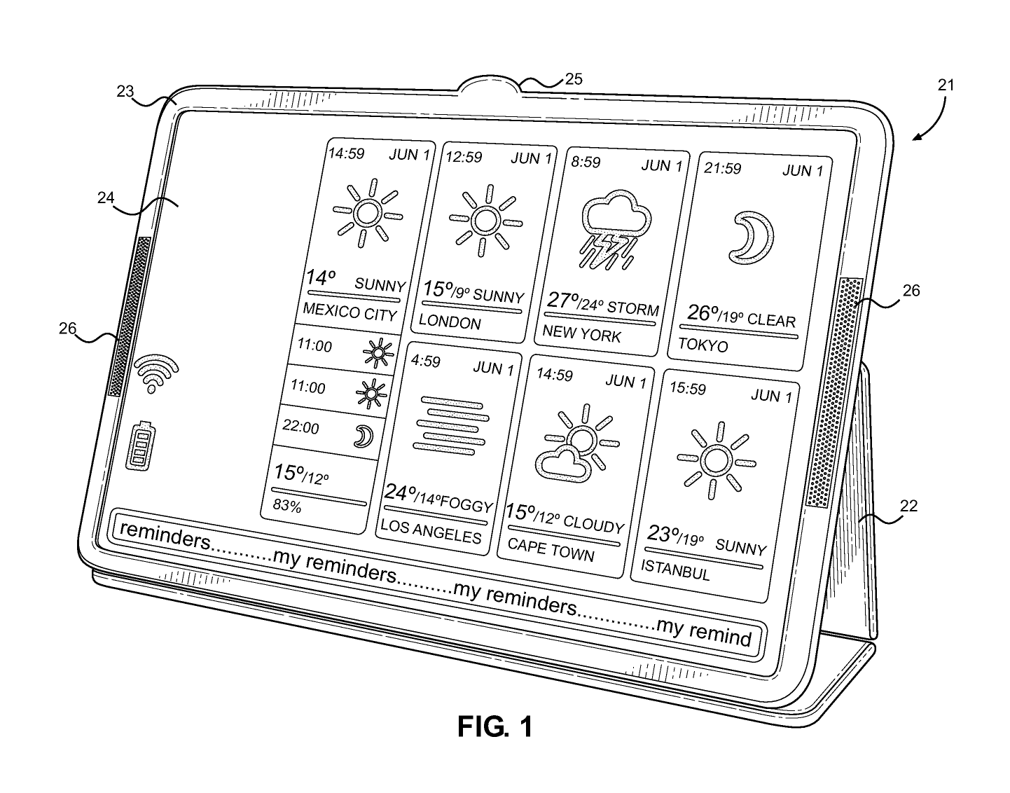

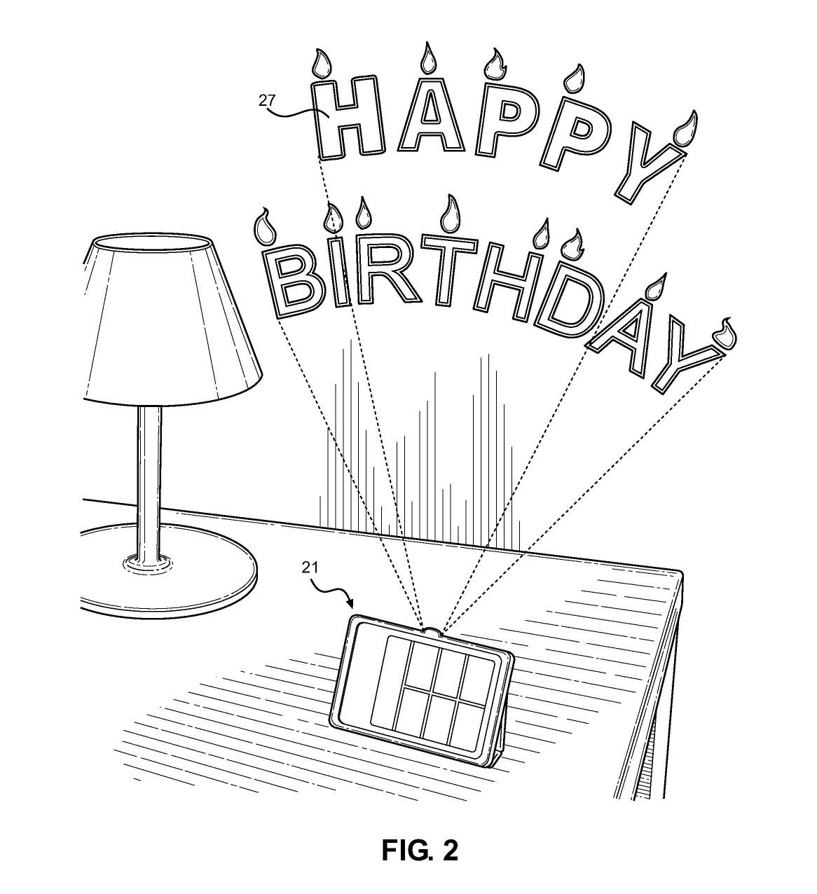

Referring now to FIGS. 1 and 2, there is shown a perspective view of the present invention and a view of the present invention projecting an image. The present alarm clock 21 comprises a tablet 23 having a display screen 24 on the front side thereof. The display screen 24 is adapted to display a user interface. Preferably, the display screen 24 comprises a touch screen so that it can be used to input information and control the user interface. The user interface includes one or more icons that can be selected to access to software applications installed on the tablet 23. In some embodiments, the user interface further includes task reminders and/or a clock. The tablet 23 further comprises speakers 26 on opposing side ends thereof. In this way, the present alarm clock 21 is adapted to play an alarm sound or music at a preset time.

The top end of the tablet 23 comprises a projector 25 thereon. The projector 25 is adapted to project a two-dimensional image 27 onto a medium. In an exemplary embodiment, it is contemplated that the projector 25 comprises a projection lens, a light source, and an LCD panel therebetween. The light passes through the LCD panel and through the projection lens. The LCD panel of the projector is connected to an image source, which comprises a stored collection of various types of images, located in the memory or a storage unit within the tablet 23. The user can select an image from the image source using the user interface on the display screen 24. Alternatively, the user can select an image from a software application installed on the tablet 23. The selected image is then displayed on the LCD panel and projected through the projector 25. The selected image can be projected on a surface, such as the wall.

In the illustrated embodiment, the projected image 27 comprises words. The projected image 27 may also comprise time, numbers, pictures, or other types of images that the user desires to display. Additionally, the projected image 27 may comprise alerts or messages. For example, the projected image 27 may remind the user of a birthday, an anniversary, or a holiday, as illustrated in FIG. 2. Preferably, the projector 25 is adapted to display an image when the alarm clock goes off at a preset time. Accordingly, the projector 25 provides a visual alert to the user.

The tablet 23 can be hung on the wall or be mounted on a stand 22. In the illustrated embodiment, the stand 22 comprises a back wall that is orthogonal to a bottom wall, forming an L-shape when viewed from the side. The stand 22 comprises a high friction surface to prevent the tablet 23 from easily slipping when mounted thereon. The back wall of the stand 22 is adapted to support the back side of the tablet 23 while the bottom wall of the stand 22 is adapted to support the bottom end of the tablet 23. Preferably, the tablet 23 is supported at an angle so that the display screen 24 is easily visible to the user. In other elements, it is contemplated that the stand 22 may comprise a variety of shapes and designs. In this regard, the specific shape of the stand 22, however, is not of primary relevance with regard to the intent of the present invention, which portends to provide an improved alarm clock.

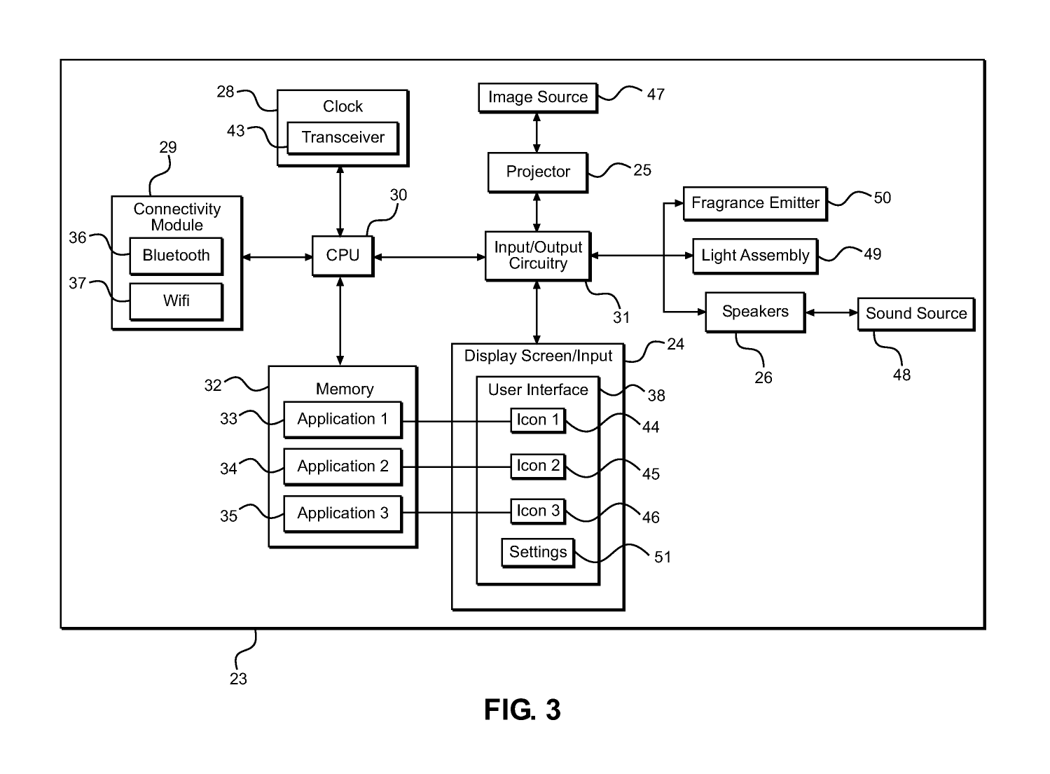

Referring now to FIG. 3, there is shown a schematic diagram of the present invention. The tablet 23 includes a display screen 24, speakers 26, and a projector 25. The display screen 24 comprises a touch screen so as to allow a user to interact with a user interface 38. The user interface 38 provides one or more icons 44, 45, 46 that can be selected to access various software applications 33, 34, 35 installed on the present alarm clock. Additionally, it is contemplated that the user interface 38 provides access to at least one settings option 51 that allows the user to modify and save display screen settings, speaker settings, connectivity module settings, clock settings, and projector settings, among others. For example, the user can use the display screen settings to customize which icons 44, 45, 46 to display on the user interface 38, and how those icons 44, 45, 46 are displayed.

Further, the projector settings allow the user to select an image to be projected through the projector 25. The projector 25 is adapted to retrieve and project an image selected from an image source 47 connected thereto. The image source 47 stores a collection of images therein. The images comprise words, pictures, numbers, letters, symbols, messages, and/or alerts. The images may be generated by the user or downloaded from an external source, such as a server. Alternatively, the projector 25 can retrieve and project an image selected from one or more software applications 33, 34, 35. In another embodiment, one or more software applications may also be configured to automatically select an image based upon a date or a preset time. In yet another embodiment, one or more software applications may be configured to automatically select news, stock, weather report, and/or other alerts and reminders to be displayed at a preset time.

In some embodiments, the tablet 23 further comprises a light assembly 49, a fragrance emitter 50, and/or a camera. The light assembly 49 is preferably an LED light and is disposed on the front side of the tablet 23. The light assembly 49 is adapted to gradually illuminate at a preset time to awaken the user. Similarly, the fragrance emitter 50 is disposed on the front side of the tablet 23. The fragrance emitter 50 is adapted to automatically emit various kind of fragrance at a preset time. Finally, the camera is disposed on the front side or on the back side of the tablet 23.

The display screen 24, the speakers 26, the projector 25, the light assembly 49, the fragrance emitter 50, and the camera are connected to an input/output circuitry 31. The input/output circuitry 31 is connected to a CPU 30. Thus, the input/output circuitry 31 facilitate communication between the CPU 30 and the display screen 24, the speakers 26, and the projector 25. The CPU 30 is further connected to a clock 28, a connectivity module 29, and a memory 32.

Preferably, the clock 28 is a radio-controlled clock that is programmable to provide a visual and/or an audible alarm at a preset time. The clock 28 comprises a transceiver 43. The transceiver 43 receives a time code transmitted by a radio transmitter connected to a time standard such as an atomic clock in order to synchronize the clock 28. In one embodiment, the clock 28 is synchronized to the time sent by a single transmitter, such as national or regional time transmitters. In another embodiment, the clock 28 is synchronized to the time sent by multiple transmitters, such as the Global Positioning System. Such systems may be used to automatically set the clock 28 when the clock 28 is moved to one location to another location.

The clock 28 can be set to trigger the projector 25, the light assembly 49, the fragrance emitter 50, and/or speakers 26 at a preset time. When triggered, the projector 25 is adapted to project an image selected from the image source 47 or one or more software applications 33, 34, 35. The light assembly 49 can illuminate at a preset time. It is preferred that the light assembly 49 illuminates gradually so as to simulate sunrise. Additionally, the fragrance emitter 50 is adapted to automatically emit various kind of fragrance at a preset time. Finally, the speakers 26 are adapted to play an alarm sound or music at the preset time. The alarm sound and music are stored in a sound source 48. Additionally, the sound source 48 comprises white noise so as to facilitate sleep when the alarm is not triggered.

Alternatively, the clock 28 can be set to actuate one or more software applications 33, 34, 35 at a preset time. For example, a video can automatically start playing on the display screen 24 at a preset time. At the preset time, the user interface 38 also automatically displays a prompt for the user to select an off button or a snooze button. The projector 25 and the speakers 26 can be deactivated by selecting the off button or by selecting the snooze button on the user interface 38. If the snooze button is selected, the clock 28 is adapted to re-trigger the projector 25 and/or the speakers 26 after a predetermined time. Thereafter, the process is repeated until the off button is selected.

The connectivity module 29 comprises a Bluetooth module 36 and/or a Wifi module 37. In this way, the present invention can be connected to other wireless devices, such as a mobile phone, external speakers, and computers, among others. Additionally, the present alarm can be connected to the Internet, thereby allowing the user to download the software applications 33, 34, 35 and any related software updates to the alarm clock.

The software applications 33, 34, 35 are stored in a memory 32. The memory 32 may comprise RAM, ROM, and/or flash memory, depending upon embodiment. Without limitation, the software applications 33, 34, 35 comprise a weather forecast application, a real-time stock tracker and alert application, a news application, a calendar application, a game application, a photo application, a video application, a social media application, and a music application, among others. The software applications 33, 34, 35 are accessible from the user interface 38 via icons 44, 45, 46 associated therewith.

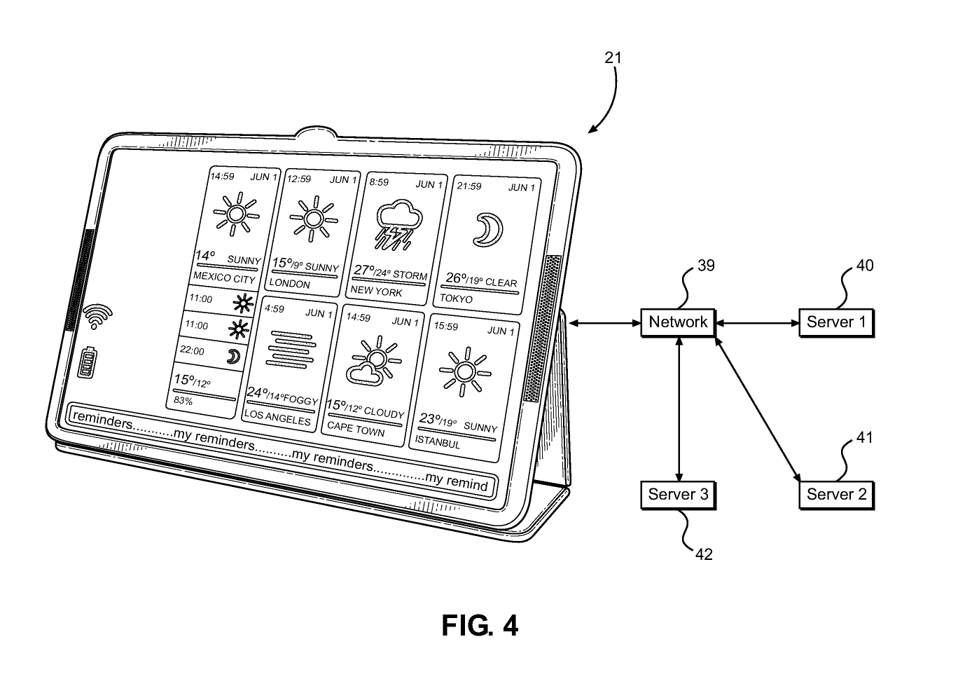

Referring now to FIG. 4, there is shown a diagram of the connectivity system of the present invention. The present alarm clock 21 is wirelessly connected to a network 39, which is in wireless communication with one or more servers 40, 41, 42. The servers 40, 41, 42 act as a data source that provide various software applications and updates that can be installed in the alarm clock 21. When the alarm clock 21 is connected to the Internet, the servers 40, 41, 42 are in continuous communication with the alarm clock 21 so that software updates can be automatically installed.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above descriptions then, it is to be realized that the optimum dimensional relationships for the parts of the invention, to include variations in size, materials, shape, form, function, and manner of operation, assembly and use, are deemed readily apparent and obvious to one skilled in the art, and all equivalent relationships to those illustrated in the drawings and described in the specifications are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A alarm clock projector, comprising:
a tablet having a display screen, speakers, and a projector;
said display screen, said speakers, and said projector connected to an input/output circuitry;
said input/output circuitry connected to a CPU;
said CPU connected to a clock, a connectivity module, and at least one memory;
said clock programmable to trigger said projector and said speaker at a preset time;
said connectivity module adapted to connect to a network.

2) The alarm clock projector of claim 1, wherein said display screen is a touch screen such that said display screen is used to input information.

3) The alarm clock projector of claim 1, wherein said connectivity module comprises a Bluetooth module.

4) The alarm clock projector of claim 1, wherein said connectivity module comprises a Wifi module.

5) The alarm clock projector of claim 1, further comprising one or more software applications stored in said at least one memory.

6) The alarm clock projector of claim 1, wherein said display screen is adapted to display a user interface.

7) The alarm clock projector of claim 6, wherein said user interface comprises one or more icons;
each of said one or more icons selected to access a software application stored in said at least one memory.

8) The alarm clock projector of claim 1, wherein said clock comprises a radio-controlled alarm clock.

9) The alarm clock projector of claim 1, wherein said projector is adapted to project a two-dimensional image onto a medium at said preset time.

10) The alarm clock projector of claim 1, wherein said tablet is mountable to an upright surface.

11) The alarm clock projector of claim 1, further comprising a stand that is adapted to support said tablet in a substantially upright manner.

12) The alarm clock projector of claim 1, wherein said projector retrieves an image from an image source.

13) The alarm clock projector of claim 1, wherein said projector retrieves an image from a software application stored in said at least one memory.

14) The alarm clock projector of claim 1, further comprising a light assembly connected to said input/output circuitry;
said light assembly adapted to gradually illuminate at said preset time.

15) The alarm clock projector of claim 1, further comprising a fragrance emitter connected to said input/output circuitry;
said fragrance emitter adapted to automatically emit fragrance at said preset time.
